(19) United States
(12) Patent Application Publication
(10) Pub. No.: US 2008/0036165 A1
(43) Pub. Date: Feb. 14, 2008

(54) Skateboard Riser Light

(76) Inventor: Roger Reinson, Calgary (CA)

Correspondence Address: Bay Area Patent Group, LLC, 13630 58TH ST. NORTH, SUITE 101, CLEARWATER, FL, 33760, US

(21) Appl. No.: 11/463,070

(22) Filed: Aug. 8, 2006

(51) Int. Cl. B62M 1/00

(52) U.S. Cl. 280/87.042

(57) ABSTRACT

The riser light is attached between the underneath surface of the deck of a skateboard and a wheel truck using the wheel truck mounting hardware as a standard riser pad would be. The riser light includes self-contained lighting assemblies positioned adjacent the underneath surface of the deck at an outward location from the main body of the riser pad, there are no electronics positioned on or within the main body. This construction, unlike prior riser lighting systems, allows the main body of the riser to function as a standard riser pad offering a smoother ride for the skateboarder on all urban surfaces, and also preventing stress fractures in the deck often caused without the use of a riser pad. The construction of the skateboard riser permits attachment to a snowboard, thereby providing a dual purpose lighting system.

### FIELD OF INVENTION

The present invention relates generally to skateboard lighting systems. More particularly, relating to a lighted skateboard truck riser adapted for attachment to a skateboard between an underneath surface of the deck and a mounting surface of a wheel truck of the skateboard and which can also to be mounted to a surface of a snowboard.

### BACKGROUND OF INVENTION

Conventional skateboards are well known and have been considered as a form of transportation, recreation, sport, and exercise. A conventional skateboard comprises a deck having an upper surface which a person stands and an underneath surface to which two wheel assemblies are spacedly attached. The wheel assemblies comprise a truck and two wheels rotatably connected to opposite ends of the truck, and a riser pad mounted between the truck and the deck.

For safety and visual enhancement, it is desirable for a skateboard or the like to have illumination to provide visual effects, to illuminate a travel path and to increase visibility of the skateboard.

The physical structure and use of a skateboard makes it difficult to incorporate or attach a lighting system to the skateboard which does not interfere with use of the skateboard, which is not easily damaged and which does not physically alter the skateboard.

Additionally, users of skateboards typically enjoy the use of snowboards. As in skateboards, it is desirable for a snowboard to have illumination to provide visual effects, to illuminate a travel path and to increase visibility of the snowboard.

Examples of skateboard and snowboard lighting systems are described in U.S. Pat. Nos. 6,540,384; 6,802,636; 4,991,066, 5,067,058; 5,119,277; 6,646,547 and is U.S. patent publications 2003/0201620 A1; 2005/0030746 A1; 2004/0100055 A1.

While the devices heretofore fulfill their respective, particular objectives and requirements, they do not provide an illumination system for a skateboard incorporating a truck riser, which is low in profile, is easy to operate, does not require modification to the skateboard for attachment, does not interfere with the normal use of a skateboard, and which can also be attached to a surface of a snowboard. As such there exists and need for a skateboard riser light which substantially departs from the prior art, and in doing so provides an apparatus primarily developed for the purpose of providing visual effects, to illuminate a travel path, and to increase visibility of a skateboard or snowboard.

### SUMMARY OF THE INVENTION

In view of the foregoing disadvantages inherent in the known types of skateboard and snowboard lighting systems now present in the prior art, the present invention provides a new skateboard riser light construction wherein the same can be used for effect illumination of a skateboard and a snowboard.

The riser light is attached between the underneath surface of the deck of a skateboard and a wheel truck using the wheel truck mounting hardware as a standard riser pad would be. The riser light includes self-contained lighting assemblies positioned adjacent the underneath surface of the deck at an outward location from the main body of the riser pad, there are no electronics positioned on or within the main body. This construction, unlike prior riser lighting systems, allows the main body of the riser to function as a standard riser pad offering a smoother ride for the skateboarder on all urban surfaces, and also preventing stress fractures in the deck often caused without the use of a riser pad. The construction also permits the thickness of the main body of the riser pad to remain the same as a standard riser pad. Each lighting assembly is self-contained including its source of illumination, power source and operation switch to control the electrical connection of the power source with the source of illumination. The operation switch is a vibration or motion activated switch which operates to power the light source only when the riser light senses motion. Further, during daytime use, each light assembly can be replaced with a dummy light assembly to save power and to provide logo opportunities.

The riser light can include an adhesive layer applied to a surface thereof facilitating the attachment of the riser light to a surface of a snowboard. The main body of the riser pad may be designed with virtually any decorative design or logo giving the riser light added cosmetic value.

In general, in one aspect, a skateboard riser light for attachment to a skateboard between an underside of a deck and a mounting surface of a wheel truck is provided. The skateboard riser light includes a riser pad having opposed first and second major surfaces and a peripheral edge including opposed first and second lateral edges and opposed first and second longitudinal edges, a first housing extending outwardly from the first longitudinal edge, and a second housing extending outwardly from the second longitudinal edge. A first self-contained lamp assembly housed in the first housing. A second self-contained lamp assembly housed in the second housing. The first and second self-contained lamp assemblies each being positioned to direct a light beam in a direction generally perpendicular to the first major surface of the riser pad, whereby when the riser pad is attached to a skateboard, the travel path below the skateboard is illuminated by the first and second self-contained lamp assemblies.

In general, in another aspect, the skateboard riser light includes a layer of adhesive applied to the first major surface, and a removable protective layer covering said layer of pressure sensitive adhesive, to facilitate the attachment of the skateboard riser light to a surface of a snowboard.

In general, in another aspect, the skateboard riser light includes a first and second self-contained lamp assembly each comprising at least one light source, a power source, and a vibration-activated switch operative to electrically connect the at least one light source to the power source in response to motion of the respective lamp assembly.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an explode perspective view of the a conventional skateboard and showing the placement of the skateboard riser light constructed in accordance with the principles of the present invention;

FIG. 2 is a bottom plan view of the skateboard of FIG. 1 showing two skateboard riser lights mounted to the skateboard between an underneath surface of a deck of the skateboard and each forward and rearward wheel trucks;

FIG. 3 is a side elevation view of the skateboard showing the two skateboard riser lights mounted to the skateboard between the underneath surface of the deck of the skateboard and each forward and rearward wheel trucks;

FIG. 4 is a front elevation view of the skateboard showing a skateboard riser light attached between the underneath surface of the deck of the skateboard and the forward wheel truck;

FIG. 5 is a bottom perspective view of the skateboard riser light;

FIG. 6 is a top perspective view of the skateboard riser light;

FIG. 7 is a cross sectional view of the skateboard riser light taken along line 6-6 in FIG. 6 through one of the housings and lamp assemblies of the skateboard riser light; and

FIG. 8 is a side elevation view of a dummy light assembly.

### DETAILED DESCRIPTION OF THE INVENTION

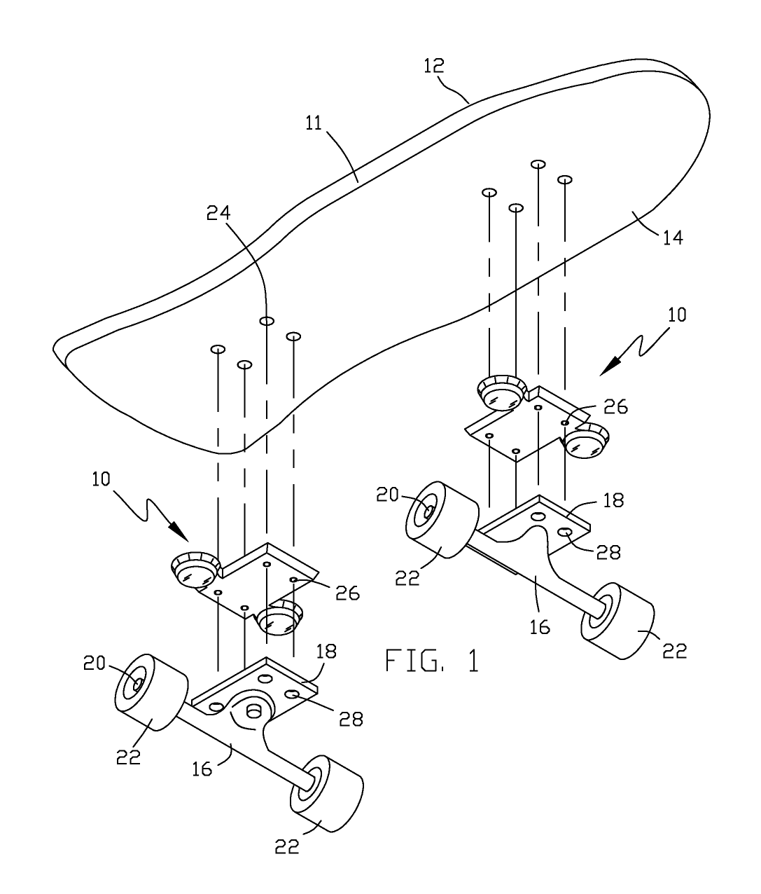

Referring now to FIGS. 1-8 of the drawings, reference numeral 10 generally designates skateboard riser light of the present invention. With particular reference to FIGS. 1-4, there is shown a conventional skateboard which comprises a deck 11 with a top surface 12 and a bottom surface 14, and a pair of wheel truck assemblies 16, each comprising, a mounting plate 18, an axle 20, and a pair of wheels 22 attached to opposite ends of the axle.

The skateboard riser light 10 is attached to the skateboard between the bottom surface 14 of the deck 11 and the mounting plate 18 of the truck assembly 16 with standard truck mounting hardware and bolts which are located through deck holes 24, skateboard riser light holes 26, and truck mounting plate holes 28.

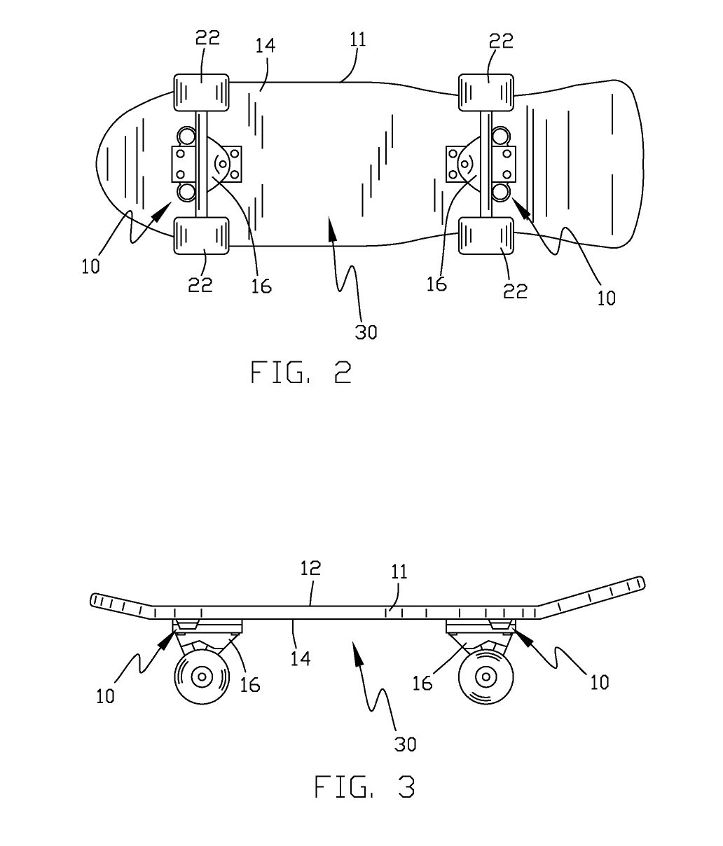

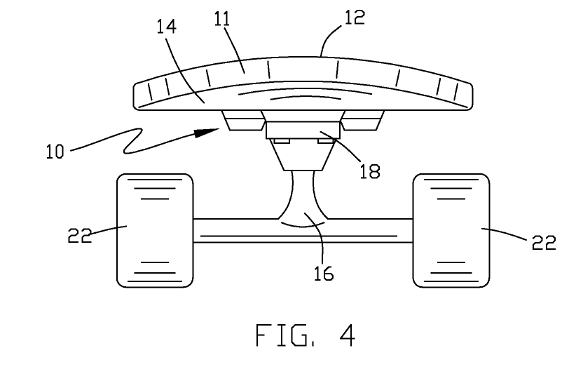

With reference now to FIG. 2, there is shown the bottom surface 14 of the deck 11. The portion 30 of the bottom surface 14 of the deck 10 between the truck assemblies 16 is typically used by a skater in performing tricks by sliding this portion of the skateboard along structures such as, for example, railings and curbs or grasping the edge of the deck 11 in this area during aerial tricks. The construction of the skateboard riser light 10 and its assembly with the skateboard affords protection to the skateboard light from damage when the skateboard is slid across such structures, as the skateboard riser light is protected against impact by the truck assemblies 16 and the wheels 22. Moreover, the construction permits a skater to grasp the edge of the deck 11 in this area during aerial tricks without interference from the skateboard riser light 10 and without interfering with the display of the skateboard riser light. Moreover, skateboards are typically carried under a person's arm with this portion adjacent the arm or mid-section, and the particular construction of the skateboard riser light 10 permits the carrying of the skateboard in this manner without discomfort to the person. FIGS. 3 and 4, further illustrate the construction and assembly of the skateboard riser light 10 with the skateboard which affords the above discussed important aspects.

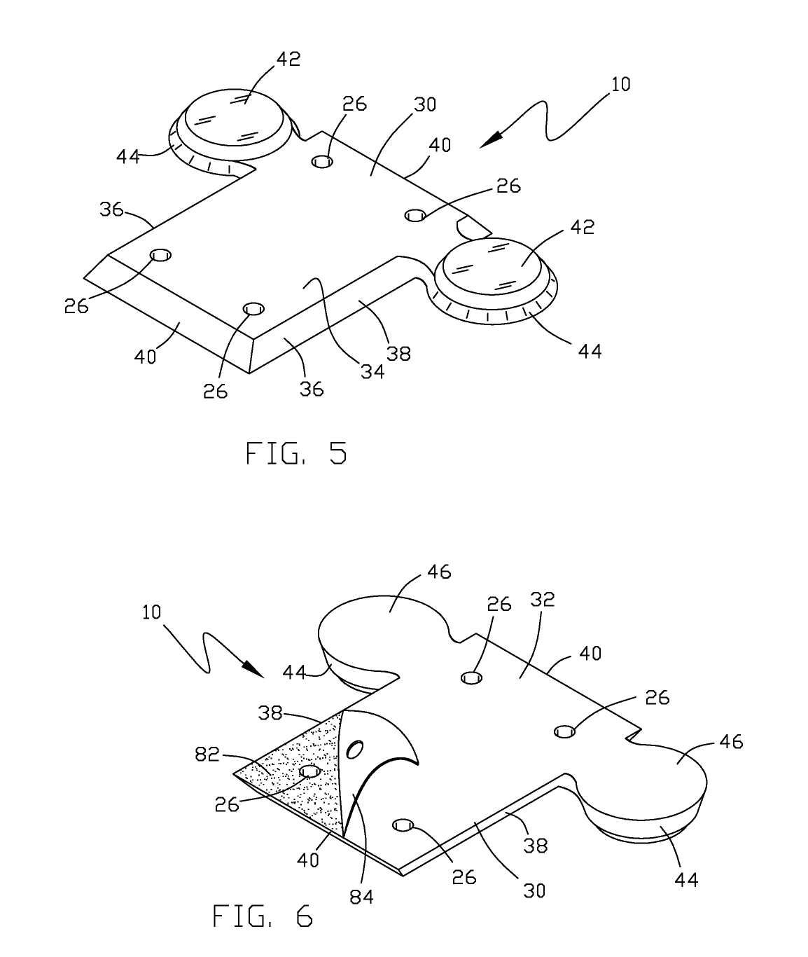

Referring now to FIGS. 5 and 6, there is shown the details of the skateboard riser light 10, which includes a pad body 30 sized to correspond to standard riser pads. The pad body 30 has a first major surface 32, an opposed second major surface 34, and a peripheral edge 36. The peripheral edge 36 comprises, opposed longitudinal edges 38 and opposed lateral edges 40. The longitudinal edges 38 are parallel to one another and the lateral edges 40 are parallel to one another and perpendicular to the longitudinal edges forming a generally rectangular pad body 30. Mounting holes 26 are formed through the pad body 30 approximate each corner.

The pad body 30 is made of durable material, such as plastic or rubber, such that when the metal truck 16 is mounted to the bottom surface 14 of the deck 11, the pad body is capable of not only retaining the truck in position but also absorbing vibration from the wheels 22 through the deck.

The skateboard riser light 10 includes a self-contained lamp assembly 42 positioned outward from each longitudinal edge 38. The lamp assemblies 42 are positioned to direct a beam of light in a direction downward from the skateboard riser light 10 generally perpendicular to the first major surface 32 or bottom surface 14 of the deck 11 to illuminate the travel path directly below and about the deck 11. Each lamp assembly 42 is completely separate and self-contained from the other lamp assembly and do not share any functioning elements. In other words, each lamp assembly 42 includes its own light source, power source and control element, which will be explained in greater detail below. Each lamp assembly 42 is contained within its own housing 44 that extends outward from each longitudinal edge 38 at a position approximate one lateral edge 40. Each housing 44 extends from its respective longitudinal edge 38 such that a bottom 46, thereof is co-planer with and forms part of the first major surface 32 of the pad body 30. The housings 44 basically form wings that extend in opposite directions from the longitudinal edges 38, and when the skateboard riser light 10 is assembly with the skateboard, the bottom 46 of each housing is adjacent to the bottom surface 14 of the deck 11. The housings 44 can be integrally formed with the pad body 30 or separately attached to it.

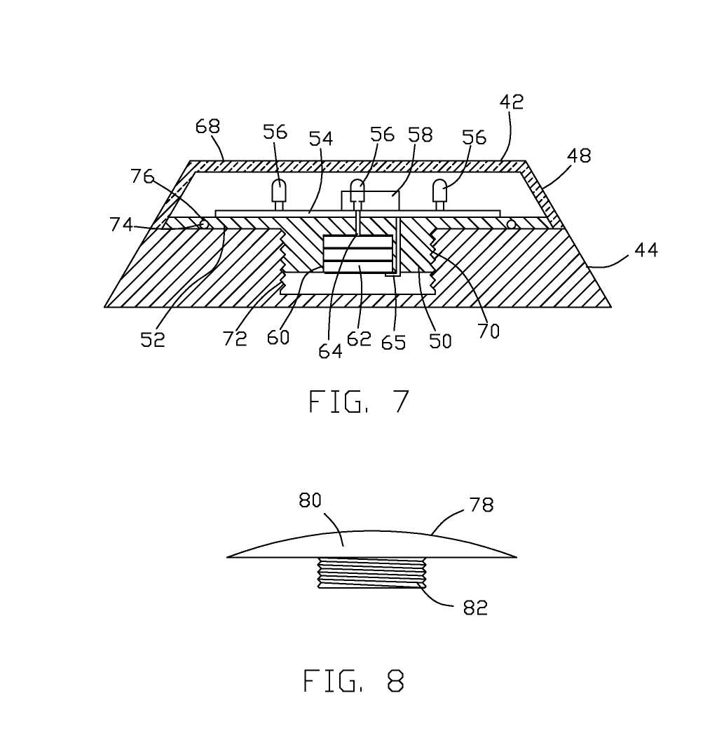

With reference now to FIG. 7, there is shown a cross section of a lamp assembly 42 and housing 44. Each lamp assembly 42 includes an upper portion 48 and a cylindrically shaped lower portion 50 that depends from the center of the upper portion. The upper portion 42 includes a support 52 which retains a printed circuit board 54 to which is mounted at least one light source 56, such as a light emitting diode (LED), a switch element 58, and first and second electrical contacts 64 and 65. A lens 68 is made integral with or attached to the support 52 and defines an internal cavity into which at least the at least one light source 56 is positioned to project a light beam from the lamp assembly 42 through the lens 68 in a direction generally perpendicular to the first major surface 32 of the pad body 30. The upper portion 50 is generally frustoconical shaped with the support 52 forming the wide end thereof with the narrow end terminating at a distance outwardly therefrom.

The lower portion 50 includes a central, longitudinal through bore 60 defining a cavity into which a power source 62 is contained. The power source 62 can be a single battery or a stacked array of multiple batteries, as shown. Positioned centrally at the top of the through bore 60 is the first electrical contact 64 which is electrically connected to a first pole of the power source 62. Extending through the lower portion 50 adjacent to the through bore 60 and terminating beyond the bottom thereof at an inwardly bend end is the second electric contact 66, which is electrically connected to a second pole of the power source 62.

The peripheral wall 70 of the lower portion 50 is threaded and the lamp assembly 42 is attached to the housing 44 by threading the lower portion into threaded bore 72 that is formed through a top surface of the housing. An elastomeric seal 74 is positioned in a radial groove 76 formed into the support 52 around the lower portion 50. The seal 74 is compress against the top surface of the housing 44 when the lamp assembly 42 is threaded into the threaded bore 72 to form a water tight seal between the lamp assembly and the housing.

The lamp assembly 42 is operated by switch element 58, which is a motion or vibration actuated switch that connects the power source 62 to the at least one light source 56 to illuminate the light source when motion or vibration is sensed by the switch element. An example of a light assembly incorporating a vibration or motion active switch is described in U.S. Pat. No. 5,465,197 to Chien, which is hereby incorporated herein in entirety by reference. In this arrangement, the lamp assembly 42 is caused to illuminate only during times of use of the skateboard which results motion or vibration sufficient enough for the switch element 58 to sense. Carrying or transporting the skateboard will generally not result in motion or vibration sufficient to be sensed by the switch element 58, thereby preventing the lamp assembly 42 from illuminating during non-use periods. Further, the use of the vibration or motion activated switch element 58 eliminates the need for a skater to have to manually operate a switch to turn the lamp assembly 42 on and off. Moreover, the elimination of a manually operated switch prevents inadvertent switch of the lamp assembly 42 on and off, such as for example during use of the skateboard.

Light source 56 can include as few as one light element to as many light elements as desired. In one instance, multiple light elements are provided and each may illuminate in a different color and may be sequentially illuminated to create a flashing pattern or other display pattern.

It is important to note, the particular construction of the skateboard riser light 10 overcomes major drawbacks in prior devices in many aspects, including providing self-contained lamp assemblies 42 that are positioned at a location outward from the body pad 30 such that truck 16 does not need to be removed to access the various elements of the lamp assembly, such as for example the power source 62. In many prior devices, the truck needs to be removed to permit the changing of the power source of the particular lighting system, this is not a requirement with the skateboard riser light 10 of the present invention. Moreover, the positioning of the lamp assemblies 42 to be forward and rearward of the forward and rearward trucks respectively while still being positioned inward from the wheels 22 approximate the axle 20 affords a great deal of protection to the lamp assemblies from damage as they are essentially guarded by the truck and the wheels.

With reference now to FIG. 8, a dummy light assembly 78 can be provided to replace the functioning light assembly 42 during periods of day time use. The dummy light assembly 78 includes a cover portion 80 and a threaded shaft 82 depending from a center of the cover. The cover portion 80 is sized to correspond to the top of the housing 44 such that the housing is completely covered when the threaded shaft 82 is threaded into the threaded bore 72 of the housing. The cover portion 80 can include various decorative designs or logos.

With reference now back to FIG. 6, another very important aspect of the skateboard riser light 10 is shown. The skateboard riser light 10 may include a layer of adhesive 82 applied to the first major surface 32 of the pad body 30 and covered by a peel-off protective layer 84. The adhesive backing 82 and the particular construction of the skateboard riser light 10 permits it to be attached to the surface of a snowboard (not shown). The dual purpose functionality of the skateboard riser light 10 provides a more versatile product making it more appealing to the market place. For example, a person who lives or travels to colder regions of the world during winter months is capable of using the skateboard riser light 10 with a skateboard during the summer months and with a snowboard during the winter months, thereby eliminating the need to purchase two separate lighting devices.

A number of embodiments of the present invention have been described. Nevertheless, it will be understood that various modifications may be made without departing from the spirit and scope of the invention. Accordingly, other embodiments are within the scope of the following claims.

I claim:

1. A skateboard riser light for attachment to a skateboard between an underside of a deck and a mounting surface of a wheel truck, the skateboard light comprising:
a riser pad having opposed first and second major surfaces and a peripheral edge including opposed first and second lateral edges and opposed first and second longitudinal edges, a first housing extending outwardly from said first longitudinal edge, and a second housing extending outwardly from said second longitudinal edge;
a first self-contained lamp assembly housed in said first housing;
a second self-contained lamp assembly housed in said second housing;
said first and second self-contained lamp assemblies each being positioned to direct a light beam in a direction generally perpendicular to said first major surface of said riser pad, whereby when said riser pad is attached to a skateboard, the travel path below the skateboard is illuminated by said first and second self-contained lamp assemblies.

2. The skateboard light of claim 1, wherein each of said first and second self-contained lamp assemblies includes:
at least one light source;
a power source; and
a vibration-activated switch operative to electrically connect said at least one light source to said power source in response to motion of said respective lamp assembly.

3. The skateboard light of claim 2, wherein said at least one light source is a LED.

4. The skateboard light of claim 3, comprising:
at least two LEDs of a different color light which are operated to flash in sequence.

5. The skateboard light of claim 2, wherein said power source is at least one battery.

6. The skateboard light of claim 2, wherein each of said first and second lamp assemblies includes:
a lamp housing having an upper portion for supporting said at least one light source and said vibration-activated switch, and a cylindrically shaped lower portion depending from said upper portion, said cylindrically shaped lower portion defining a cavity for receiving said power source, and having a peripheral wall with a threaded outer surface;
a lens attached to said upper portion and enclosing said at least one light source; and
wherein each of said first and second housings of said riser pad include a threaded bore for threadably receiving said cylindrically shaped lower portion of said lamp housing of each of said first and second lamp assemblies respectively.

7. The skateboard light of claim 6, wherein each of said first and second housings of said riser pad is frustoconical shaped and tapers from wide to narrow in a direction from said first major surface toward said second major surface, the wide end forming part of said first major surface with the narrow end defining said threaded bore; and wherein said upper portion of said lamp housing is frustoconical shaped with the diameter of the wide end thereof corresponding to the diameter of the narrow end of the housing of said riser pad.

8. The skateboard light of claim 7, further comprising:
a sealing element compressed between said narrow end of said housing and said wide end of said upper portion.

9. The skateboard light of claim 1, further comprising:
a layer of adhesive applied to said first major surface; and
removable protective layer covering said layer of pressure sensitive adhesive.

10. A riser pad for a skateboard which comprises a deck and two wheel assemblies each comprising a truck mounted to an underneath surface of the deck and two wheels rotatably mounted at two ends of the truck, the riser pad being mountable between the underneath surface of the deck and the truck and comprising:
a pad body having a first major surface, an opposed second major surface, and a peripheral edge including opposed first and second lateral edges and opposed first and second longitudinal edges, a first housing extending laterally outward from said first longitudinal edge such that a bottom surface thereof forms part of said first major surface, and a second housing extending laterally outward from said second longitudinal edge such that a bottom surface thereof forms part of said first major surface, a first self-contained lamp assembly housed in said first housing;
a second self-contained lamp assembly housed in said second housing;
said riser pad being mountable between the underneath surface of the deck and the truck with the first major surface in contact with the underneath surface of the deck and the second major surface being in contact with the truck; and
said first and second self-contained lamp assemblies each being positioned to direct a light beam in a direction generally perpendicular to the underneath surface of the deck when said riser pad is attached to a skateboard, whereby the travel path below the skateboard is illuminated by said first and second self-contained lamp assemblies.

11. The riser pad of claim 10, further comprising:
an adhesive layer applied to the first major surface of said pad body; and
a protective covering removably applied to said adhesive layer.

12. The riser pad of claim 10, wherein each of said first and second self-contained lamp assemblies includes:
at least one light source;
a power source; and
a vibration-activated switch operative to electrically connect said at least one light source to said power source in response to motion of said respective lamp assembly.

13. The riser pad of claim 12, wherein said at least one light source is a LED.

14. The riser pad of claim 13, comprising:
at least two LEDs of a different color light which are operated to flash in sequence.

15. The riser pad of claim 12, wherein said power source is at least one battery.

16. The riser pad of claim 12, wherein each of said first and second lamp assemblies includes:
a lamp housing having an upper portion for supporting said at least one light source and said vibration-activated switch, and a cylindrically shaped lower portion depending from said upper portion defining a cavity for receiving said power source, said cylindrically shaped lower portion having a peripheral wall with a threaded outer surface;
a lens attached to said upper portion and enclosing said at least one light source; and
wherein each of said first and second housings of said riser pad include a threaded bore for threadably receiving said cylindrically shaped lower portion of said lamp housing of each of said first and second lamp assemblies respectively.

17. The riser pad of claim 16, wherein each of said first and second housings of said riser pad is frustoconical shaped and tapers from wide to narrow in a direction from said first major surface toward said second major surface, the wide end forming part of said first major surface with the narrow end defining said threaded bore; and wherein said upper portion of said lamp housing is frustoconical shaped with the diameter of the wide end thereof corresponding to the diameter of the narrow end of the housing of said riser pad.

18. The riser pad of claim 17, further comprising:
an o-ring positioned being compressed between said narrow end of said housing and said wide end of said upper portion to seal said threaded bore.
